(19) United States
(12) Patent Application Publication
(10) Pub. No.: US 2026/0350908 A1
(43) Pub. Date: Nov. 5, 2026

(54) VIDEO GENERATION METHOD AND APPARATUS, DEVICE, AND COMPUTER READABLE STORAGE MEDIUM

(71) Applicant: SHANGHAI XIYU JIZHI TECHNOLOGY CO., LTD., Shanghai (CN)

(72) Inventors: Yucong Zhou, Shanghai (CN); Zhihao Wang, Shanghai (CN); Bin Yang, Shanghai (CN)

(21) Appl. No.: 19/118,791

(22) PCT Filed: Dec. 29, 2022
(86) PCT No.: PCT/CN2022/143239

§ 371 Date: Apr. 7, 2025

(30) Foreign Application Priority Data
Oct. 9, 2022 (CN) 202211226180.6

(51) Int. Cl. G06T 15/06; G06T 7/73

(52) U.S. Cl. CPC G06T 15/06; G06T 7/73; G06T 2200/04; G06T 2207/10016; G06T 2207/20084

(57) ABSTRACT

Disclosed in the present invention are a video generation method and apparatus, a device, and a computer readable storage medium. The method comprises: acquiring first information representing first light; acquiring second information of multiple first key points of a target object for multiple times; according to the first information and the second information obtained for multiple times, respectively generating multiple first key point fusion features corresponding to the first light ray; inputting the first information and the multiple first key point fusion features into a pre-trained neural light field (NeLF) model for multiple times in a paired manner, so as to obtain multiple static images of the target object; and synthesizing the multiple static images into a video.

### CROSS-REFERENCE TO RELATED APPLICATIONS

The present disclosure claims the priority to the Chinese patent application with the filling No. 2022112261806, filed on Oct. 9, 2022, the entire content of which is incorporated herein by reference for all purposes.

### TECHNICAL FIELD

The present disclosure relates to the technical field of artificial intelligence, and particularly to a video generation method and apparatus, a device, and a computer-readable storage medium.

### BACKGROUND ART

The neural light field proposed in recent years is a powerful tool for solving the problem of novel view synthesis at present. The traditional neural radiance field (NeRF) utilizes a multi-layer perceptron (MLP) neural network to implicitly learn a static three-dimensional (3D, 3Dimensions) scene. For each static 3D scene, a large number of images with known camera parameters are required to train the neural network. The trained neural network can achieve the rendering of image results from any angle.

The neural network used by NeRF (an 11-layer MLP) itself is very small, but rendering one pixel requires sampling many points on a light ray (for example, hundreds of points), which leads to an extremely high computational cost for rendering an image. In addition, NeRF can only reconstruct static 3D images. For the reconstruction of dynamic 3D videos in NeLF, it is understandable to directly introduce a time parameter for implementation, similar to the existing NeRF implementation method.

However, video generation based on NeRF requires a large amount of rendering time, and at the same time, a time parameter is required for implementation. Therefore, how to improve the generation speed of three-dimensional videos and further detach from the time parameter is an urgent problem to be solved.

### SUMMARY

The main objective of the present disclosure is to provide a video generation method and apparatus, a device, and a computer-readable storage medium, aiming to solve the technical problem of slow rendering speed and dependence on the time parameter in existing video generation methods. The technical solution is as follows.

In a first aspect, the embodiments of the present disclosure provide a video generation method, including: acquiring first information representing a first light ray; acquiring second information of multiple first key points of a target object multiple times, wherein the second information includes spatial coordinates of the key points and features of the key points; respectively generating multiple first key point fusion features corresponding to the first light ray according to the first information and the second information, which is acquired multiple times; pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model; and synthesizing the multiple static images into a video.

In a second aspect, the embodiments of the present disclosure provide a video generation apparatus, including: a light ray information acquisition module, configured for acquiring first information representing a first light ray; a key point information acquisition module, configured for acquiring second information of multiple first key points of a target object multiple times, wherein the second information includes spatial coordinates of the key points and features of the key points; a key point encoding module, configured for respectively generating multiple first key point fusion features corresponding to the first light ray according to the first information and the second information, which is acquired multiple times; an image acquisition module, configured for pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model; and a video synthesis module, configured for synthesizing the multiple static images into a video.

In a third aspect, the embodiment of the present disclosure provides an electronic device, comprising: a memory, a processor, and a computer program stored in the memory and executable on the processor, wherein the computer program, when executed by the processor, implements the steps of the method as described above in any one of the first aspect.

In a fourth aspect, an embodiment of the present disclosure provides a computer storage medium, wherein the computer storage medium stores multiple instructions, and the instructions are adapted to be loaded by a processor and executed to perform the steps of the method as described above in any one of the first aspect.

In the embodiments of the present disclosure, by sequentially inputting the second information of the multiple first key points of the target object, when generating a static image corresponding to the first light ray based on the neural light field, each static image is actually associated with different key points input each time. In this way, although all static images correspond to the first light ray, each generated static image can be different due to variations in key points. This achieves the effect of driving static images to “move” using key points and then synthesizing a video based on the generated static images. This not only enables 3D video synthesis but also decouples video generation from time information or time parameters. In addition, by using the high-speed characteristics of the neural light field, the video generation speed can be further improved.

### BRIEF DESCRIPTION OF DRAWINGS

In order to more clearly illustrate the embodiments of the present disclosure or the technical solution in the prior art, the drawings required to be used in the description of the embodiments or the prior art will be briefly introduced as follows. Obviously, the drawings described below are only some embodiments of the present disclosure. Those of ordinary skill in the art, without paying inventive labor, may also obtain other drawings according to these drawings.

FIG. 1 is an exemplary schematic diagram of a video generation method provided in an embodiment of the present disclosure;

FIG. 2 is a flowchart schematic diagram of a video generation method provided in an embodiment of the present disclosure;

FIG. 3 is a schematic diagram of key points in a video generation method provided in an embodiment of the present disclosure;

FIG. 4 is a schematic comparison diagram of a neural radiance field model and a neural light field model in a video generation method provided in an embodiment of the present disclosure;

FIG. 5 is a structural schematic diagram of a video generation apparatus provided in an embodiment of the present disclosure; and

FIG. 6 is a structural schematic diagram of a video generation device provided in an embodiment of the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, and not all of the embodiments. Based on the embodiments in the present disclosure, all other embodiments obtained by those of ordinary skill in the art without making inventive efforts are within the scope of protection of the present disclosure.

The video generation apparatus can be a terminal device such as a mobile phone, computer, tablet, smartwatch, or in-vehicle device, or it can be a module within a terminal device configured to implement the video generation method. The video generation apparatus is capable of acquiring the first information representing a first light ray; and acquiring the second information of a plurality of the first key points of a target object multiple times. The second information includes spatial coordinates of the key points and features of the key points. The video generation apparatus is capable of respectively generating multiple first key point fusion features corresponding to the first light ray according to the first information and the second information, which is acquired multiple times; then, pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model. The video generation apparatus is also capable of synthesizing the multiple static images into a video.

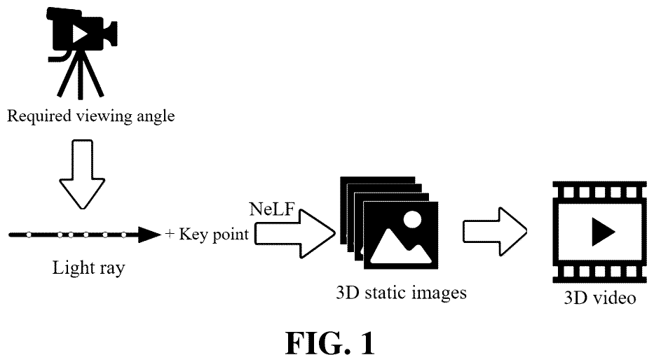

Referring to FIG. 1, FIG. 1 is an exemplary schematic diagram of a video generation method provided in the embodiment of the present disclosure. The process shown in the figure is for synthesizing a 3D video of a target object. In practical application scenarios, a light ray can be obtained based on the desired viewpoint of the target object. The light ray or the viewing angle is not necessarily required to exist in reality and can be a viewpoint that was not present during the training of the NeLF model, meaning it can be a completely new viewpoint. Then, based on the key point information of the target object, the NeLF model is driven to obtain multiple 3D static images corresponding to the light ray. Afterward, a 3D video is synthesized from the multiple static images. The required viewing viewpoint in FIG. 1 refers to the viewpoint for viewing the target object.

The video generation method provided in the present disclosure will now be described in detail in conjunction with specific embodiments.

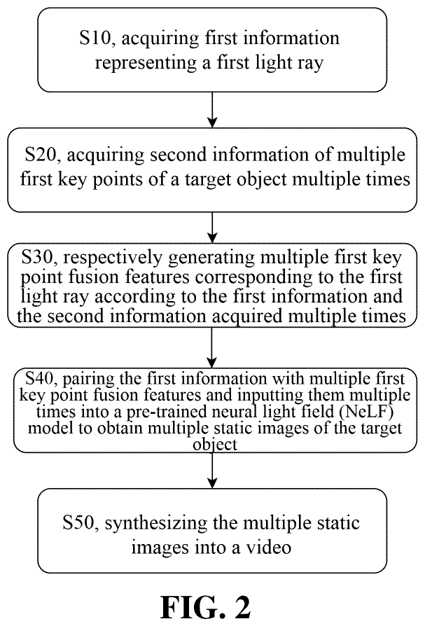

Referring to FIG. 2, FIG. 2 is a flowchart schematic diagram of a video generation method provided in an embodiment of the present disclosure. As shown in FIG. 2, the method of the embodiment of the present disclosure can include the following steps S10-S50.
S10: acquiring first information representing a first light ray.
S20: acquiring second information of multiple first key points of a target object multiple times, wherein the second information includes spatial coordinates of the key points and features of the key points.
S30: respectively generating multiple first key point fusion features corresponding to the first light ray according to the first information and the second information, which is acquired multiple times.
S40: pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model.
S50: synthesizing the multiple static images into a video.

In the present embodiment, a video generation method based on NeLF is provided, which enables the synthesis of a three-dimensional video without requiring a time parameter while achieving a faster rendering speed.

In the field of computer vision technology, NeLF and NeRF have similar functionalities and can both be used for rendering a 3D target object. The input of NeRF is a point in the scene (for example, inputting parameters representing the spatial coordinates of the point and the direction of the sight line where the point is located), and the corresponding output is the color RGB and opacity of the point. Based on the color and opacity of each point, a 3D target object can be rendered. The input of NeLF is a light ray, and the corresponding output is directly the pixel values on the image corresponding to the light ray. For 3D image reconstruction, NeLF has a significant advantage, namely high speed. To obtain the RGB of one pixel in an image, NeLF only requires a single neural network computation, and NeRF requires running the neural network computation hundreds of times. In addition, when rendering based on NeRF, since a large number of points need to be sampled on each light ray and the image resolution is high, the rendering speed is relatively slow. Therefore, an optimization using NeLF is provided, where NeLF directly provides the color and other parameters of the light ray. By using the fast rendering characteristics of NeLF, efficient dynamic rendering is achieved.

Each step is described in detail below.

S10: acquiring first information representing a first light ray.

Optionally, the first light ray can be represented by a vector of a virtual light ray obtained according to the video viewing viewpoint. The first light ray can also be represented by multiple sampling points, for example, using 16 sampling points and the direct positional relationship between adjacent sampling points to represent the first light ray. For example, after determining the orientation viewing angle at the starting position of the light ray, a ray (light ray) is obtained. Then, multiple sampling points are uniformly sampled along the light ray, and the multiple sampling points are connected into a vector to represent the first light ray. As another example, following the same approach, after uniformly sampling multiple sampling points along the light ray, the relative positions between adjacent sampling points among the multiple sampling points are obtained. Instead of combining the multiple sampling points into a vector, the first light ray is represented directly using the information of the sampling points and the relative positional relationship between the sampling points.

In step S10, the first information representing a first light ray is acquired. Optionally, the first information is information of multiple sampling points representing the first light ray, or the first information is information of a vector representing the first light ray. For example, the first information includes the spatial coordinates and viewpoints of 20 sampling points. As another example, the first information is the information of vector, where the vector reflects the position and viewpoint of the first light ray in space, such as a vector formed by connecting at least two sampling points on the first light ray.

It is understandable that since different NeLF models may require different input parameters, the first information in this solution may vary depending on the input parameters required by the actual NeLF model used.

S20: acquiring second information of multiple first key points of a target object multiple times, wherein the second information includes spatial coordinates of the key points and features of the key points.

Specifically, the target object refers to the object expected to be generated in the video, which can be an object, a person, a building, etc. For example, if a video of a person speaking needs to be generated, the target object can be the head, upper body, or entire body of the person. For example, if the target object is the head of the person, when speaking, the person will change the facial expressions, such as the opening or closing of the lips, changes in eyebrow positions, and variations in cheek contours. Multiple first key points can be provided on the face of a person. By obtaining multiple first key points on the face of the person and tracking the specific changes in the spatial coordinates of these key points when the person is speaking, multiple second information of the first key points can be obtained. For example, the face of a person can be provided with hundreds of first key points, such as more than 400 first key points. The first key points of the target object vary with the target object, such as facial key points, body key points, and key points of a vehicle.

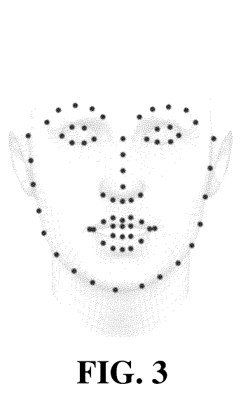

Referring to FIG. 3, FIG. 3 is a schematic diagram of key points in a video generation method provided in an embodiment of the present disclosure, and the black dots in the figure represent the key points of the head of a person. It can be understood that the number of key points can be determined based on the target object. Generally, the more first key points there are, the higher the accuracy of the simulated motion in the generated video is.

It should be noted that the features of the key points do not change; and what changes are the spatial coordinates of the key points. The features of key points in the embodiments of the present disclosure can also be understood as semantic features of key points, which assign corresponding semantics to the key points. For example, the semantics of a key point at the corner of the mouth is “mouth corner”, so even if the key point changes position in space due to facial expressions, it still corresponds to the same semantics or feature.

S30: respectively generating multiple first key point fusion features corresponding to the first light ray according to the first information and the second information, which is acquired multiple times.

Specifically, in step S30, the first light ray can be associated with or bound to the first key points, enabling key points to drive NeLF. In step S30, the first information needs to be acquired only once, and the second information needs to be acquired multiple times. For example, the second information is continuously acquired, and each acquisition of the second information corresponds to the generation of a first key point fusion feature, thereby continuously obtaining the first key point fusion features.

Optionally, for the first information and the second information, which is acquired each time, at least one second key point associated with the first light ray is determined from multiple first key points. Attention computation is performed on the second information of at least one second key point and the first information to obtain the first key point fusion feature. The attention computation in the embodiment can use existing computation methods and is not specifically limited here.

When the first information is information of multiple sampling points representing the first light ray, at least one second key point can be determined from multiple first key points based on the positional relationship between each sampling point of the multiple sampling points and the multiple first key points. For example, assuming there are 12 sampling points and 456 first key points, the distance between each of the 12 sampling points and the 456 first key points is calculated, and the first key points with a distance less than or equal to a preset threshold are determined as second key points. As another example, besides distance, the direction angle between the sampling points and the first key points can also be considered. A reference plane can be selected, and the angle between the sampling point, the first key point, and the reference plane is calculated. If the angle is greater than a preset angle, the first key point is determined not to be a second key point.

When the first information is information of the vector representing the first light ray, at least one second key point can be determined from multiple first key points based on the positional relationship between the vector and the multiple first key points. For example, the projection distance of each first key point onto the vector or the perpendicular distance from each first key point to the vector is calculated, and the first key points with a projection distance or perpendicular distance less than or equal to a preset threshold are determined as second key points. As another example, besides distance, the direction angle between the points on the vector and the first key points can also be considered. A reference plane can be selected, and the point on the vector closest to the first key point is determined. The angle between the point, the first key point, and the reference plane is calculated. If the angle is greater than a preset angle, the first key point is determined not to be a second key point.

Optionally, the corresponding relationship between the key points and the sampling points can also be set. When determining at least one second key point associated with the first sampling point from multiple first key points, it can be obtained from the corresponding relationship mapping table.

In the embodiment, determining the second key points can reduce the number of key points associated with the first light ray, thereby reducing computational complexity, saving computing resources, and accelerating processing speed. For example, key points near the eyes drive eye movements, and key points near the mouth drive mouth movements. Key points near the eyes will not drive mouth movements. Therefore, it is necessary to select the second key points associated with the first sampling point from the first key points to make the key point drive faster.

S40: pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model.

In the embodiment, the first information and the first key point fusion feature are inputs to the NeLF model. The pre-trained NeLF model can render different three-dimensional images based on the first information and various first key point fusion features.

The neural light field (NeLF) model in the present disclosure can use an existing NeLF model but requires pre-training. For example, during the training of an existing NeLF model, only the first information and the corresponding images need to be labeled, which in turn the trained NeLF model takes the first information as input and outputs a three-dimensional image. In the embodiment, during the training of the NeLF model, it is necessary to annotate the first information, the first key point fusion feature, and the corresponding image, so that the trained NeLF model receives both the first information and the first key point fusion feature as inputs.

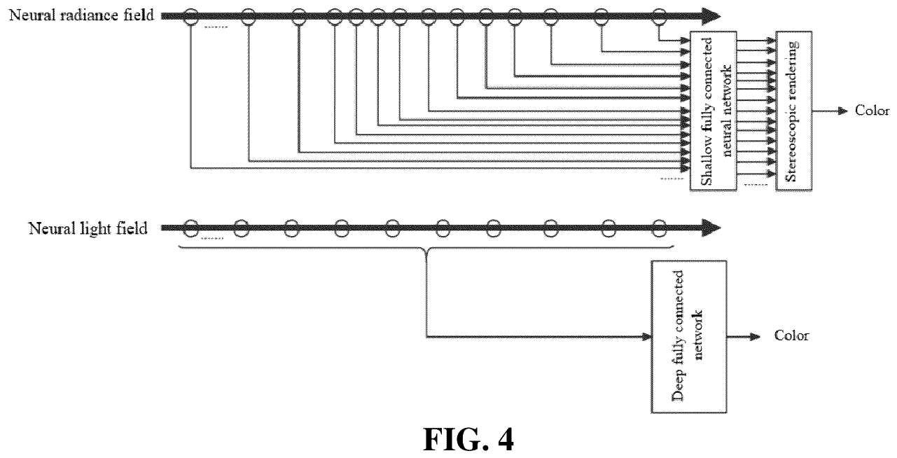

Referring to FIG. 4, FIG. 4 is a schematic comparison diagram of a neural radiance field model and a neural light field model in a video generation method provided in the embodiment of the present disclosure. As shown in FIG. 4, the data volume required for training the neural radiance field is significantly greater than that of the neural light field. The neural radiance field requires training on N sampling points along one light ray, whereas the neural light field utilizes, for example, a vector to represent a light ray and conducts training based on the light ray. Therefore, the training data volume is 1/N of that required for the neural radiance field. Due to the significant reduction in training data volume and the differences in network structures, the training speed is remarkably improved.

S50: synthesizing the multiple static images into a video.

Specifically, the generated static images are used as frames in the video, and multiple images are synthesized into a video. It can be understood that, for example, if the generated video is a talking person, in the training process, a talking video of a person is collected and then performed by frame sampling (e.g., FPS=60); then, the spatial coordinates of the key points in each frame of the image is obtained, and the corresponding second information is generated, followed by training of the NeLF model. During the video synthesis process, by executing the above steps S10-S40, multiple static images can be continuously obtained, and by utilizing the multiple static images, real-time dynamic video can be generated. It can be understood that, during the video synthesis process, second information of at least one key point is input, which can be obtained using an existing extraction method for the key point.

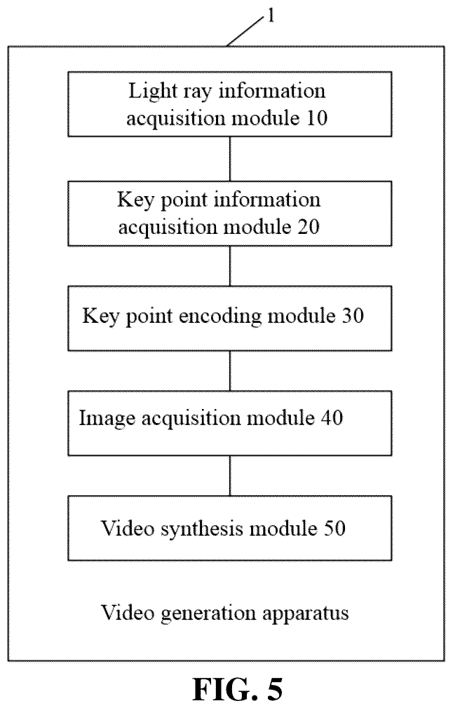

The following will provide a detailed description of the video generation apparatus in the embodiment of the present disclosure in conjunction with FIG. 5. It should be noted that the video generation apparatus in FIG. 5 is configured to execute the method of the embodiments shown in FIG. 2 to FIG. 4 of the present disclosure. For the sake of clarity, only the parts relevant to the embodiments of the present disclosure are shown. For specific technical details that are not disclosed here, the embodiments shown in FIG. 2 to FIG. 4 of the present disclosure can be referred to.

Referring to FIG. 5, FIG. 5 is a structural schematic diagram of a video generation apparatus provided in an embodiment of the present disclosure. The video generation apparatus can be implemented entirely or partially through software, hardware, or a combination of both. The apparatus 1 includes a light ray information acquisition module 10, a key point information acquisition module 20, a key point encoding module 30, an image acquisition module 40, and a video synthesis module 50.

The light ray information acquisition module 10 is configured for acquiring the first information representing a first light ray;
the key point information acquisition module 20 is configured for acquiring second information of multiple first key points of a target object multiple times, wherein the second information includes spatial coordinates of the key points and features of the key points;
the key point encoding module 30 is configured for respectively generating multiple first key point fusion features corresponding to the first light ray according to the first information and the second information, which is acquired multiple times;
the image acquisition module 40 is configured for pairing the first information with multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model; and
the video synthesis module 50 is configured for synthesizing multiple static images into a video.

Optionally, for the first information and the second information, which is acquired each time, at least one second key point associated with the first light ray is determined by the key point encoding module 30 from multiple first key points. Attention computation is performed on the second information of at least one second key point and the first information to obtain the first key point fusion feature.

Optionally, the first information is information of multiple sampling points representing the first light ray, or the first information is information of a vector representing the first light ray.

Optionally, the key point encoding module 30 is further configured for determining at least one second key point associated with multiple sampling points from multiple first key points based on the positional relationship between the multiple sampling points and the multiple first key points.

Optionally, the key point encoding module 30 is further configured for determining at least one second key point associated with multiple sampling points from multiple first key points based on the positional relationship between the vector and the multiple first key points.

Optionally, the key point encoding module 30 is further configured for calculating the distance between the spatial coordinates of each sampling point of multiple sampling points and the spatial coordinates of multiple first key points; and determining at least one first key point with a distance less than or equal to a preset threshold as the at least one second key point.

It should be noted that the video generation apparatus provided in the above embodiments, when executing the video generation method, is described only by dividing the functional modules as mentioned above for illustrative purposes. In practical applications, the above functions can be allocated to different functional modules as needed, that is, the internal structure of the device can be divided into different functional modules to achieve all or part of the functions described above. Additionally, the video generation apparatus provided in the above embodiments and the video generation method embodiments belong to the same concept, and the implementation process is detailed in the method embodiments, which will not be elaborated on here.

The sequence numbers of the embodiments in the present disclosure are only for description purposes and do not indicate the superiority of the embodiments.

The present disclosure further provides a computer-readable storage medium, and a computer program is stored on the computer-readable storage medium. When executed by a processor, the computer program implements the video generation method of the embodiments as shown in FIGS. 2 to 4 above. The specific execution process can be referred to in the detailed description of the embodiments shown in FIGS. 2 to 4, which will not be elaborated on here.

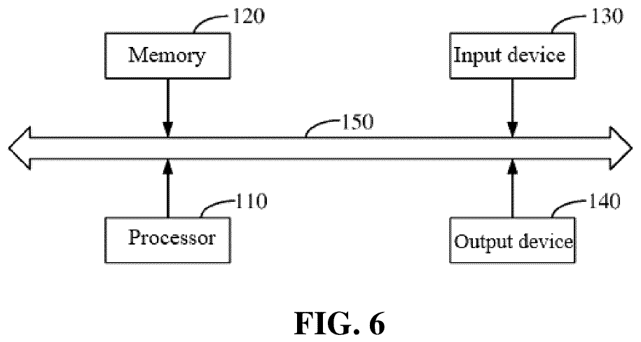

Referring to FIG. 6, FIG. 6 shows a structural schematic diagram of a video generation device provided in an embodiment of the present disclosure. The video generation device in the present disclosure can include one or more of the following components: a processor 110, a memory 120, an input device 130, an output device 140, and a bus 150. The processor 110, the memory 120, the input device 130, and the output device 140 can be connected via the bus 150.

The processor 110 can include one or more processing cores. The processor 110 connects various components within the video generation device through various interfaces and circuits and various executes functions of the terminal 100 and processes data by running or executing instructions, programs, code sets, or instruction sets stored in the memory 120 and by calling data stored in the memory 120. Optionally, the processor 110 can be implemented in at least one hardware form selected from digital signal processing (DSP), field-programmable gate array (FPGA), and programmable logic array (PLA). The processor 110 can integrate one or a combination of a central processing unit (CPU), a graphics processing unit (GPU), and a modem. The CPU primarily processes the operating system, user interfaces, and applications. The GPU is configured for rendering and drawing display content. The modem is configured for processing wireless communication. It can be understood that the modem can also be implemented separately through a communication chip instead of being integrated into the processor 110.

The memory 120 can include random access memory (RAM), and it can also include read-only memory (ROM). Optionally, the memory 120 includes a non-transitory computer-readable storage medium. The memory 120 can be configured to store instructions, programs, code, code sets, or instruction sets. The memory 120 can include a program storage region and a data storage region. The program storage region can store instructions for implementing the operating system, instructions for implementing at least one function (such as a touch function, audio playback function, image playback function, etc.), and instructions for implementing the above method embodiments. The operating system can be an Android system, including systems developed based on the Android system, an iOS system developed by Apple, including systems developed based on the iOS system, or other systems.

The memory 120 can be divided into an operating system space and a user space, wherein the operating system runs in the operating system space, and native and third-party applications run in the user space. To ensure that different third-party applications achieve better operational performance, the operating system allocates corresponding system resources for each third-party application. However, different application scenarios within the same third-party application have different system resource demands. For example, in a local resource loading scenario, the third-party application requires a higher disk read speed; and in an animation rendering scenario, the third-party application requires higher GPU performance. Since the operating system and third-party applications operate independently, the operating system often cannot promptly perceive the current application scenario of the third-party application, leading to the inability of the operating system to perform targeted system resource adaptation based on the specific application scenario of the third-party application.

To enable the operating system to distinguish specific application scenarios of third-party applications, data communication between third-party applications and the operating system needs to be established so that the operating system can obtain the current scenario information of third-party applications at any time and subsequently perform targeted system resource adaptation based on the current scenario.

The input device 130 is configured to receive input instructions or data. The input device 130 can include, but is not limited to, a keyboard, a mouse, a camera, a microphone, or a touch device. The output device 140 is configured to output instructions or data. The output device 140 can include, but is not limited to, a display device and a speaker. In one example, the input device 130 and the output device 140 can be integrated, wherein the input device 130 and the output device 140 form a touch display screen.

The touch display screen can be designed as a full-screen, curved screen, or irregular screen. The touch display screen can also be designed as a combination of a full-screen and a curved screen or a combination of an irregular screen and a curved screen, which is not limited to the embodiments of the present disclosure.

Additionally, those skilled in the art can understand that the structure of the video generation device shown in the above figures does not limit the video generation device. The video generation device can include more or fewer components than illustrated, wherein some components can be combined, or the arrangement of components can be different. For example, the video generation device can further include components such as a radio frequency circuit, an input unit, a sensor, an audio circuit, a wireless fidelity (Wi-Fi) module, a power supply, and a Bluetooth module, which will not be elaborated on herein.

In the video generation device shown in FIG. 6, the processor 110 can be used to invoke the computer program stored in the memory 120 and specifically execute the method described in the above method embodiment.

Those of ordinary skill in the art can understand that the implementation of all or part of the processes in the above-described embodiment methods can be completed by instructing related hardware through a computer program. The program can be stored in a computer-readable storage medium; and when executed, the program can include the processes of the embodiment methods as described above. The storage medium can be a magnetic disk, an optical disk, a read-only memory (ROM), a random access memory (RAM), etc.

The above disclosure is merely a preferred embodiment of the present disclosure and should not be used to limit the scope of claims of the present disclosure. Therefore, equivalent changes made based on the claims of the present disclosure shall still fall within the scope covered by the present disclosure.

1. A video generation method, comprising:
acquiring first information representing a first light ray;
acquiring second information of multiple first key points of a target object multiple times, wherein the second information comprises spatial coordinates of the key points and features of the key points;
respectively generating multiple first key point fusion features corresponding to the first light ray according to the first information and the second information, which is acquired multiple times;
pairing the first information with the multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model; and
synthesizing the multiple static images into a video.

2. The method according to claim 1, wherein the step of respectively generating multiple first key point fusion features corresponding to the first light ray according to the first information and the second information, which is acquired multiple times comprises:
determining at least one second key point associated with the first light ray from the multiple first key points based on the first information and the second information, which is acquired each time; and
performing attention computation on the second information of the at least one second key point and the first information to obtain the first key point fusion feature.

3. The method according to claim 1-or 2, wherein the step of acquiring first information representing a first light ray comprises:
the first information being information of multiple sampling points representing the first light ray; or
the first information being information of a vector representing the first light ray

4. The method according to claim 3, wherein when the first information is the information of the multiple sampling points representing the first light ray, the step of determining at least one second key point associated with the first light ray from the multiple first key points comprises:
determining the at least one second key point associated with the multiple sampling points from the multiple first key points based on a positional relationship between the multiple sampling points and the multiple first key points.

5. The method according to claim 3, wherein when the first information is the information of the vector representing the first light ray, the step of determining at least one second key point associated with the first light ray from the multiple first key points comprises:
determining the at least one second key point associated with the multiple sampling points from the multiple first key points based on a positional relationship between the vector and the multiple first key points.

6. The method according to claim 4, wherein the step of determining the at least one second key point associated with the multiple sampling points from the multiple first key points comprises:
calculating a distance between spatial coordinates of each sampling point of the multiple sampling points and spatial coordinates of the multiple first key points; and
determining at least one first key point with a distance less than or equal to a preset threshold as the at least one second key point.

7. The method according to claim 5, wherein the step of determining the at least one second key point associated with the vector from the multiple first key points comprises:
calculating a distance between the vector and spatial coordinates of the multiple first key points; and
determining at least one first key point with a distance less than or equal to a preset threshold as the at least one second key point.

8. A video generation apparatus, comprising:
a light ray information acquisition module, configured for acquiring first information representing a first light ray;
a key point information acquisition module, configured for acquiring second information of multiple first key points of a target object multiple times, wherein the second information comprises spatial coordinates of the key points and features of the key points;
a key point encoding module, configured for respectively generating multiple first key point fusion features corresponding to the first light ray according to the first information and the second information, which is acquired multiple times;
an image acquisition module, configured for pairing the first information with the multiple first key point fusion features and inputting them multiple times into a pre-trained neural light field (NeLF) model to obtain multiple static images of the target object, wherein the number of the multiple static images is equal to the number of times the second information of the first key points is acquired, and each time, the first information is paired with one first key point fusion feature before being input into the NeLF model; and
a video synthesis module, configured for synthesizing the multiple static images into a video.

9. An electronic device, comprising a memory, a processor, and a computer program stored in the memory that can be executed on the processor, wherein, when executing the computer program, the processor implements the steps of the method according to claim 1.

10. A computer-readable storage medium, wherein the computer-readable storage medium stores multiple instructions, and the instructions are adapted to be loaded by a processor and executed to perform the steps of the method according to claim 1.

11. The method according to claim 2, wherein the step of acquiring first information representing a first light ray comprises:
the first information being information of multiple sampling points representing the first light ray; or
the first information being information of a vector representing the first light ray.

12. The method according to claim 11, wherein when the first information is the information of the multiple sampling points representing the first light ray, the step of determining at least one second key point associated with the first light ray from the multiple first key points comprises:
determining the at least one second key point associated with the multiple sampling points from the multiple first key points based on a positional relationship between the multiple sampling points and the multiple first key points.

13. The method according to claim 11, wherein when the first information is the information of the vector representing the first light ray, the step of determining at least one second key point associated with the first light ray from the multiple first key points comprises:
determining the at least one second key point associated with the multiple sampling points from the multiple first key points based on a positional relationship between the vector and the multiple first key points.

14. The method according to claim 12, wherein the step of determining the at least one second key point associated with the multiple sampling points from the multiple first key points comprises:
calculating a distance between spatial coordinates of each sampling point of the multiple sampling points and spatial coordinates of the multiple first key points; and
determining at least one first key point with a distance less than or equal to a preset threshold as the at least one second key point.

15. The method according to claim 13, wherein the step of determining the at least one second key point associated with the vector from the multiple first key points comprises:
calculating a distance between the vector and spatial coordinates of the multiple first key points; and
determining at least one first key point with a distance less than or equal to a preset threshold as the at least one second key point.

16. The electronic device according to claim 9, wherein the step of respectively generating multiple first key point fusion features corresponding to the first light ray according to the first information and the second information, which is acquired multiple times comprises:
determining at least one second key point associated with the first light ray from the multiple first key points based on the first information and the second information, which is acquired each time; and
performing attention computation on the second information of the at least one second key point and the first information to obtain the first key point fusion feature.

17. The electronic device according to claim 9, wherein the step of acquiring first information representing a first light ray comprises:
the first information being information of multiple sampling points representing the first light ray; or
the first information being information of a vector representing the first light ray.

18. The electronic device according to claim 16, wherein the step of acquiring first information representing a first light ray comprises:
the first information being information of multiple sampling points representing the first light ray; or
the first information being information of a vector representing the first light ray.

19. The computer-readable storage medium according to claim 10, wherein the step of respectively generating multiple first key point fusion features corresponding to the first light ray according to the first information and the second information, which is acquired multiple times comprises:
determining at least one second key point associated with the first light ray from the multiple first key points based on the first information and the second information, which is acquired each time; and
performing attention computation on the second information of the at least one second key point and the first information to obtain the first key point fusion feature.

20. The computer-readable storage medium according to claim 10, wherein the step of acquiring first information representing a first light ray comprises:
the first information being information of multiple sampling points representing the first light ray; or
the first information being information of a vector representing the first light ray.
